(19) United States
(12) Patent Application Publication
(10) Pub. No.: US 2015/0113456 A1
(43) Pub. Date: Apr. 23, 2015

(54) METHOD, SYSTEM FOR CONTROLLING DYNAMIC MAP-TYPE GRAPHIC INTERFACE AND ELECTRONIC DEVICE USING THE SAME

(71) Applicants: Fu Tai Hua Industry (Shenzhen) Co., Ltd., Shenzhen (CN); HON HAI PRECISION INDUSTRY CO., LTD., New Taipei (TW)

(72) Inventor: XIAO-GUANG LI, Shenzhen (CN)

(21) Appl. No.: 14/520,520

(22) Filed: Oct. 22, 2014

(30) Foreign Application Priority Data
Oct. 23, 2013 (CN) 201310500153.8

(51) Int. Cl. G06F 3/0484; G06F 3/0482; G06F 3/0481

(52) U.S. Cl. CPC G06F 3/04842; G06F 3/04817; G06F 3/0482
USPC 715/765

(57) ABSTRACT

A dynamic map-type graphic interface includes a number of user interface (UI) components. Each UI component is associated with one corresponding application program of the electronic device. The dynamic map-type graphic interface is a single-layer graphic interface made up of the UI components spliced together and around the center of the dynamic map-type graphic interface. The UI component can be enlarged via a time-extended selection command, and can display an overview relating to the associated application program or the file.

### FIELD

The present disclosure relates to graphic user interface technologies, and particularly to a dynamic map-type graphic interface, an electronic device providing the dynamic map-type graphic interface, and a method for the electronic device to control the dynamic map-type graphic interface.

### BACKGROUND

User interfaces (UIs) are physical or virtual mediums in which a user interacts with an electronic device. Most electronic devices use graphic user interface (GUI) components supported in an operating system (OS). The GUIs of electronic devices may have many application icons, making it necessary to arrange the application icons in different layers or pages of the GUI.

### BRIEF DESCRIPTION OF THE DRAWINGS

Implementations of the present technology will now be described, by way of example only, with reference to the attached figures.

FIG. 1 is an isometric view of an embodiment of an electronic device.

FIG. 2 is a block diagram of the electronic device of FIG. 1.

FIG. 3 is a diagrammatic view of a first embodiment of a dynamic map-type graphic interface.

FIG. 4 is a diagrammatic view of another embodiment of a dynamic map-type graphic interface.

FIG. 5 is a flowchart of an embodiment of a method for providing the dynamic map-type graphic interface.

FIG. 6 is a diagrammatic view of a second embodiment of a dynamic map-type graphic interface.

FIG. 7 is a flowchart of an embodiment of a groups control method for controlling the dynamic map-type graphic interface of the FIG. 6.

FIG. 8 a diagrammatic view of an embodiment of a moving process of the dynamic map-type graphic user interface.

FIG. 9 is a diagrammatic view of a first embodiment of an overview process of the dynamic map-type graphic user interface.

FIG. 10 is a diagrammatic view of a second embodiment of an overview process of the dynamic map-type graphic user interface.

FIG. 11 is a diagrammatic view of a third embodiment of an overview process of the dynamic map-type graphic user interface.

FIG. 12 is a diagrammatic view of another embodiment of an overview process of the dynamic map-type graphic user interface.

FIG. 13 is a flowchart of an embodiment of a control method for controlling a user interface of the electronic device employing the dynamic map-type graphic interface.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The term “comprising,” when utilized, means “including, but not necessarily limited to”; it specifically indicates open-ended inclusion or membership in the so-described combination, group, series and the like.

The present disclosure is described in relation to a controlling method and a controlling system for controlling a map-type graphical user interface with a plurality of graphical representative user interface (UI) components.

The controlling system includes an input controlling module, an overview controlling module and a generating module. The input controlling module is configured to determine, at an electronic device, whether an input command input by a user is a time-extended selection command. The overview controlling module is configured to determine, at an electronic device, a new size of a selected UI component corresponding to the time-extended selection command. The generating module is configured to update, based on the new size of the selected UI component at the electronic device, the map-type graphical user interface by updating the size of the selected UI component.

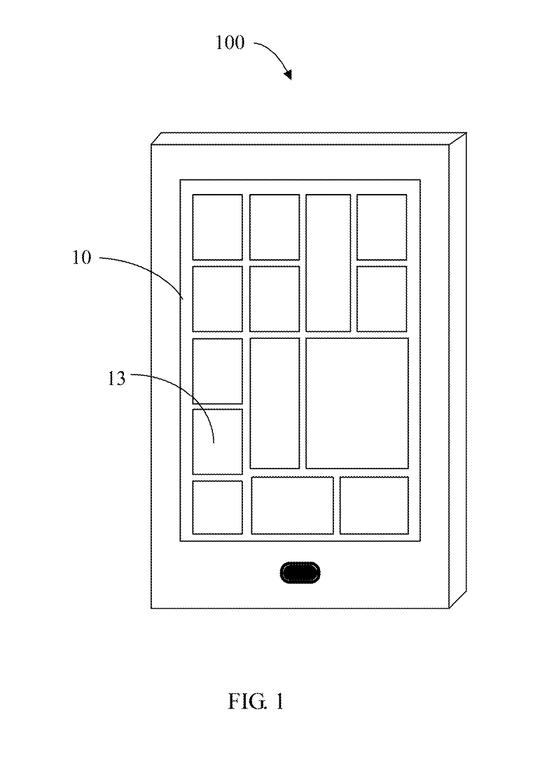

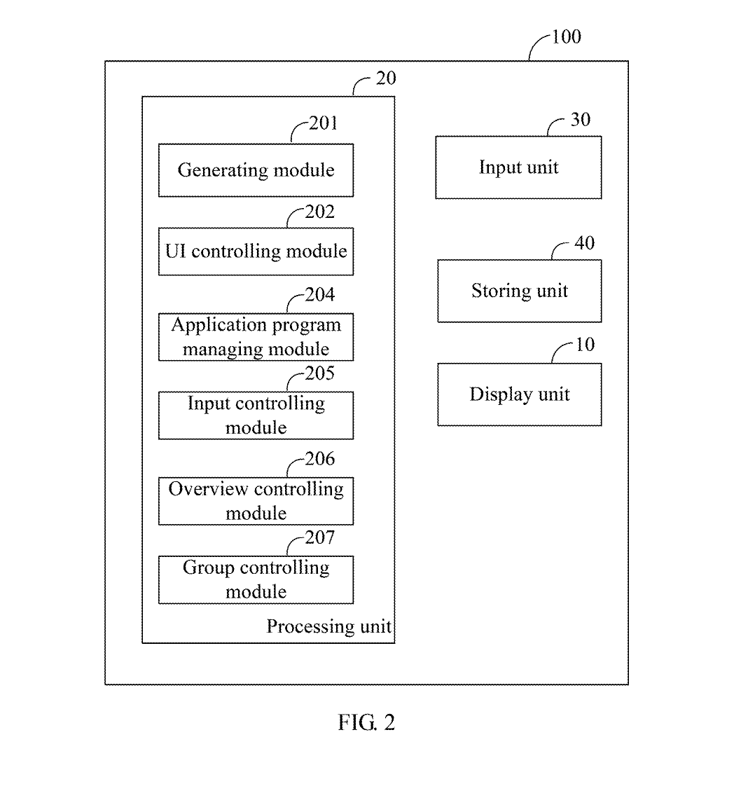

FIGS. 1 and 2 illustrate an electronic device 100 of one embodiment. The electronic device 100 includes a display unit 10, a processing unit 20, an input unit 30, and a storage unit 40. The display unit 10 of the electronic device 100 can be any size, and the electronic device 100 can be, without limitation, a television, an electronic whiteboard, a desktop personal computer, a notebook, a tablet personal computer, a smart phone, or a device with a display. The electronic device 100 provides a user interface (UI), (not labeled) displayed on the display unit 10. A number of UI components 13 are arranged in the UI, the UI components 13 can be arranged in a single layer or in multiple layers.

In at least one embodiment, the storage unit 40 is a non-transitory computer-readable medium configured to store a number of documents and multimedia files, such as video files, music files, and images. The storage unit 40 further stores a number of application programs and UI components 13 associated with the application programs. The UI components 13 include application icons and different kinds of interactive widgets. Each application icon and widget is associated with a corresponding application program. In at least one embodiment, the widget is a window for dynamically displaying images or information, such as weather information or time, or a thumbnail of a document, video, or image stored in the storage unit 40. In other embodiments, the widget is an interactive widget configured to provide feedback and display a processing result in response to a manual input. For example, the interactive widget is a currency converter, which includes an input box for inputting a currency and a currency value, and displays a converted result.

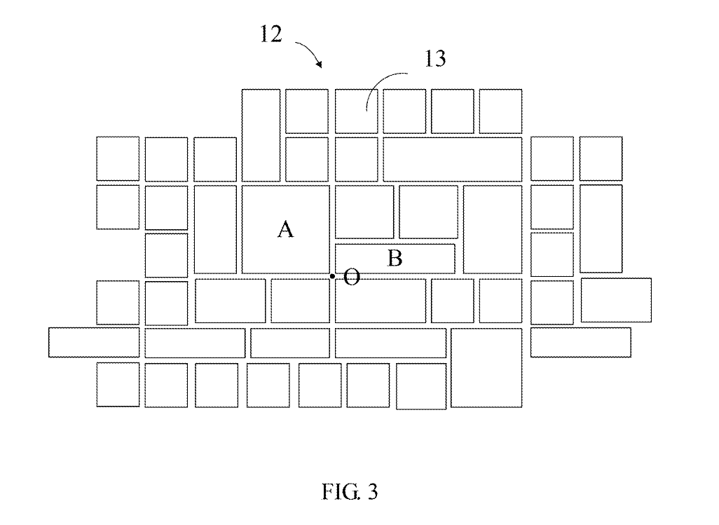

The display unit 10 is configured to simultaneously display videos, documents, Internet web pages, running interface of programs, a UI, and the like. The processing unit 20 is configured to run the application programs and control the display unit 10. The storage unit is further configured to store software instruments. The software instruments are run by the processing unit 20 for enabling the electronic device 100 to implement a dynamic map-type graphic interface 12 (shown in FIG. 3).

The input unit 30 can be selected from a contactless input device or a contact-type input device. The contactless input device can be a wireless control technology, such as gesture control technology or voice control technology. The contact-type input device can be a touch input device, such as a capacitive touch screen, a resistive touch screen, an Infrared touch screen, or other optical touch input devices, or other types of input devices, such as a keyboard or a button.

The processing unit 20 includes a generating module 201, a UI controlling module 202, an application program managing module 204, an input controlling module 205, an overview controlling module 206 and a group controlling module 207.

FIG. 3 illustrates a first embodiment of a dynamic map-type graphic interface 12. The dynamic map-type graphic interface 12 is made up of the UI components 13 on a single layer. The UI components 13 are dynamically arranged according to a predetermined rule. Each of the UI components 13 is associated with one application program.

In at least one embodiment, the UI components 13 are arranged around a predetermined center O and spliced together to form the dynamic map-type graphic interface 12. A size of the dynamic map-type graphic interface 12 increases as the number of the UI components 13 increases. Each of the UI components 13 is a block of the map. A size, shape, and content of the block are determined by a character of the associated application program, or set by a user.

The size of the UI component 13 is measured by a predetermined unit of measurement.

In at least one embodiment, one unit is defined as 0.2 inches. For example, if the size of a UI component 13 is 1×4, the horizontal size of the UI component 13 is 0.2 inches, and the vertical size of the UI component 13 is 0.8 inches.

In another embodiment, the size of the UI component 13 is defined by pixel values. For example, if the size of the UI component 13 is 50×50, the horizontal size and the vertical size of the UI component 13 are both 50 pixels.

For example, a block A of the dynamic map-type graphic interface 12 is an application program for the weather and has a 3×3 size. Therefore, the horizontal size and the vertical size of the block A are both 0.6 inches. The content of the block A can include a static or dynamic image showing weather information of a city.

The UI components 13 are arranged around the predetermined center O according to the predetermined rule and spliced together. The UI components 13 are spliced together means that the UI components 13 are arranged around the center one by one according to the predetermined rule. The UI components 13 can be arranged closer to the center O according to a frequency of use, a time of installation, or other condition defined by a user. In other embodiments, arrangement of the UI components 13 on the dynamic map-type graphic interface 12 is random or determined by a user.

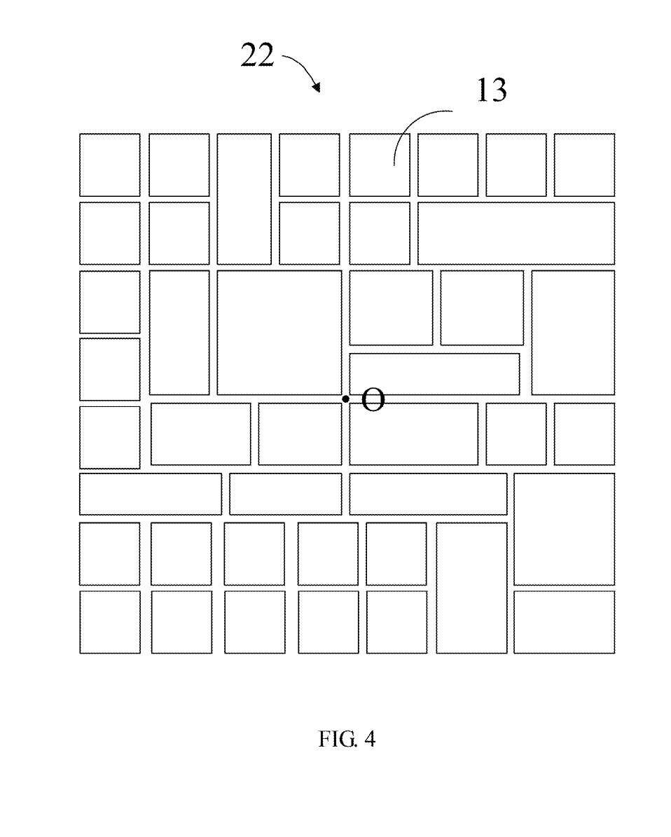

FIG. 4 illustrates another embodiment of a dynamic map-type graphic interface 22. A difference between the dynamic map-type graphic interface 22 and the dynamic map-type graphic interface 12 of the first embodiment is that the dynamic map-type graphic interface 22 is rectangular and has a fixed aspect ratio. As the number of the UI components 13 increases, the size of the rectangle increases to maintain the fixed aspect ratio of the dynamic map-type graphic interface 22.

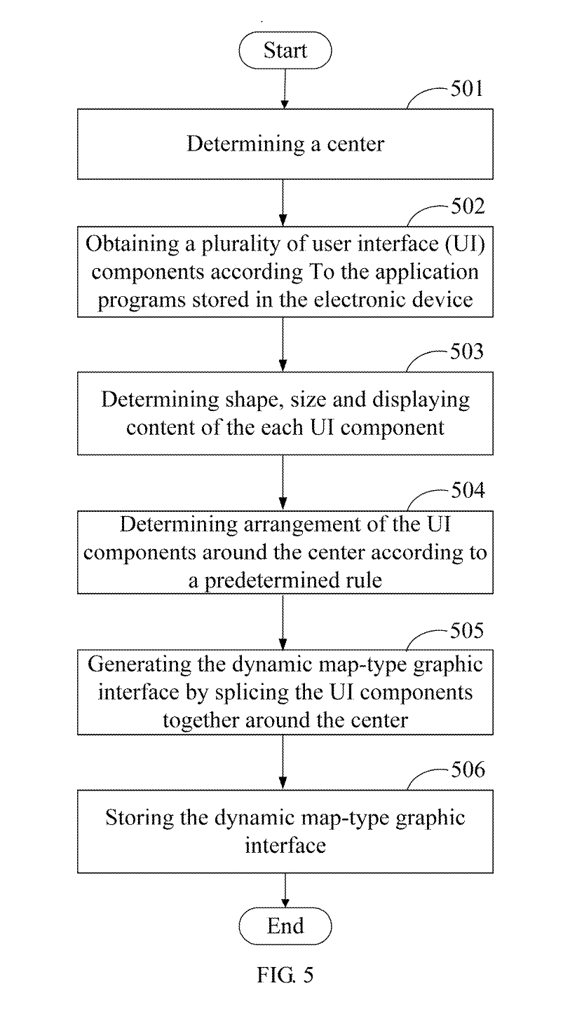

Referring to FIG. 5, a flowchart of a method for providing the dynamic map-type graphic interface 12, is presented in accordance with an example embodiment. The example method is provided by way of example, as there are a variety of ways to carry out the method. The method described below can be carried out using the configurations illustrated in FIG. 2, for example, and various elements of these figures are referenced in explaining example method. Each block shown in FIG. 5 represents one or more processes, methods or subroutines, carried out in the example method. Furthermore, the illustrated order of blocks is illustrative only and the order of the blocks can change according to the present disclosure. Additional blocks can be added or fewer blocks may be utilized, without departing from this disclosure. The example method can begin at block 501.

In block 501, the generating module 201 determines a center O.

In block 502, the application program managing module 204 obtains the number of the UI components 13 according to the application programs stored in the electronic device 100.

In block 503, the application program managing module 204 determines the shape, size, and content of each UI component 13 according to the character of the application program associated with each UI component 13, or according to user input.

In block 504, the generating module 201 determines the arrangement of the UI components 13 around the center O according to the first predetermined rule. In other embodiments, the arrangement of the UI components 13 is random or determined by a user.

In block 505, the generating module 201 generates the dynamic map-type graphic interface 12 by splicing the UI components 13 together around the center O.

In block 506, the dynamic map-type graphic interface 12 is stored in the storage unit 40 of the electronic device 100.

In other embodiments, the generating module 201 splices the UI components 13 together around the center O to form a dynamic picture.

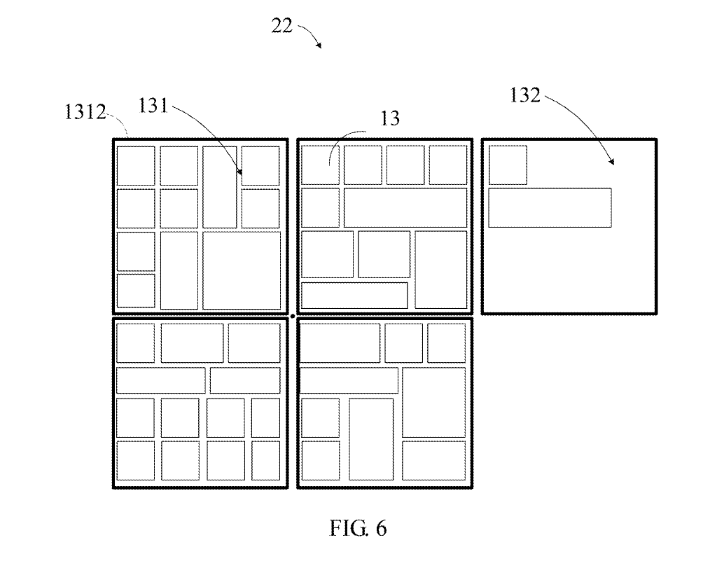

FIG. 6 illustrates a second embodiment of a dynamic map-type graphic interface 32. The dynamic map-type graphic interface 32 is also made up of the UI components 13 on a single page; each of the UI components 13 is associated with one application program. A difference between the dynamic map-type graphic interface 32 and the dynamic map-type graphic interface 12 of the first embodiment is that the dynamic map-type graphic interface 32 includes a number of groups 131. The UI components 13 of the dynamic map-type graphic interface 32 are grouped into the number of groups 131, each of the groups 131 includes at least one UI component 13. The groups 131 are dynamically arranged according to a predetermined rule and spliced together to form the dynamic map-type graphic interface 32.

Similar to the first embodiment, the application program managing module 204 determines the shape, size, and content of each UI component 13 of the dynamic map-type graphic interface 32 according to the character of the application program associated with each UI component 13, or according to user input. The character of the associated application program includes size parameter, shape parameter, content parameter, arrangement parameter and group parameter of the corresponding UI components 13. The group parameter of the character of the application program includes a group name configured to define which group 131 the corresponding UI components 13 belong to. The group parameter can be set by the associated application program or set by manual input.

For example, a UI component 13 is a shortcut icon or a thumbnail icon of a multi-media file stored in the storage unit 40, the UI component 13 is associated to a video player program to play the multi-media file when the UI component 13 is activated. The group name contained in the group parameter of the character of the video player program is “Video”. In another example, a UI component 13 is a shortcut icon of Internet video broadcast program, the corresponding group name is also “Video”. If the character of the video player program is empty, the corresponding group name is defaulted to “Null”.

The group controlling module 207 is configured to obtain the group parameter of the each UI components 13 of the associated application program, and group the UI components 13 into the corresponding group 131 according the group parameters. In detail, the group controlling module 207 obtains the group name of group parameter of the each UI component 13 of the associated application program, and gathers the UI components 13 which have the same group parameter into the corresponding group 131.

In at least one embodiment, the dynamic map-type graphic interface 32 further includes frames 1312 circumscribing around the group 13.

The generating module 201 is configured to determine the arrangement of the group 131 around the center O according to a second predetermined rule, and generate the dynamic map-type graphic interface 32 by splicing the group 13 together around the center O. The group 131 is spliced together means the groups 131 are arranged around the center O one by one according to the second predetermined rule. In at least one embodiment, the groups 131 can be arranged closer to the center O according to a frequency of use, a time of installation, or other conditions defined by a user. In other embodiments, arrangement of the group 131 on the dynamic map-type graphic interface 32 is random or determined by a user.

In at least one embodiment, the generating module 201 further determines the arrangement of the UI components 13 relative to the center O in the group 131 according to a third predetermined rule, when the arrangement of the group 131 has been determined. For example, the UI components 13 can be arranged closer to the center O according to a frequency of use.

In another embodiment, the generating module 201 further determines the arrangement of the UI components 13 in the group 131 according to a fourth predetermined rule, when the arrangement of the group 131 has been determined. For example, the UI components 13 can be orderly arranged in row array or column array according to a frequency of use, a time of installation, or other conditions defined by a user.

In other embodiments, arrangement of the UI components 13 in the group 131 is random or determined by a user.

In at least one embodiment, when the group controlling module 207 determines that the group parameter of the new application program is empty, the group controlling module 207 further groups the UI component 13 into a group 131 according to manual input.

The group 131 of the dynamic map-type graphic interface 32 is a block made up of the corresponding UI components 13 spliced together. In at least one embodiment, the groups 131 are rectangular and have a fixed aspect ratio, the UI components 13 can be spliced via an original size or a compressed size.

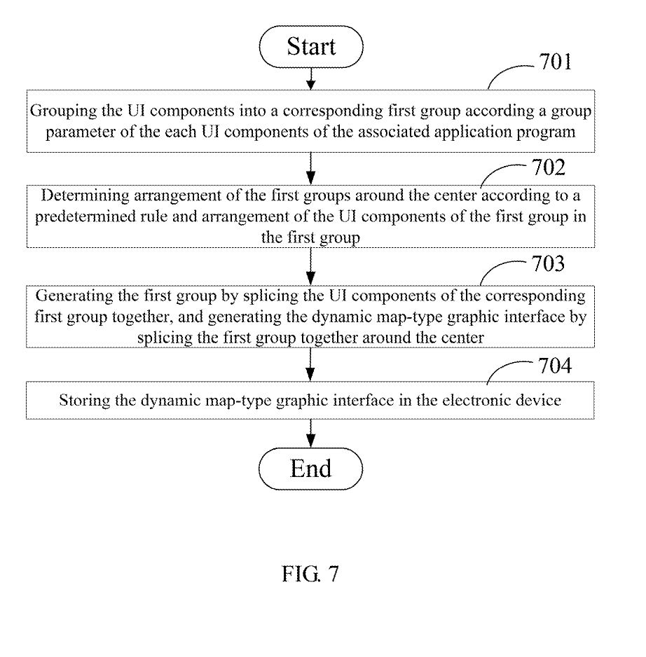

Referring to FIG. 7, a flowchart of a group control method for controlling the dynamic map-type graphic interface 32, is presented in accordance with an example embodiment. The example method is provided by way of example, as there are a variety of ways to carry out the method. The method described below can be carried out using the configurations illustrated in FIG. 2, for example, and various elements of these figures are referenced in explaining example method. Each block shown in FIG. 7 represents one or more processes, methods or subroutines, carried out in the example method. Furthermore, the illustrated order of blocks is illustrative only and the order of the blocks can change according to the present disclosure. Additional blocks can be added or fewer blocks may be utilized, without departing from this disclosure. The example method can begin at block 701.

In block 701, the group controlling module 207 groups the UI components 13 into the corresponding group 131 according the group parameters of the each UI component 13 of the associated application program. In detail, the group controlling module 207 obtains the group parameter of the each UI component 13 of the associated application program, and groups the UI components 13 into the corresponding group 131 according to the group parameters.

In block 702, the generating module 201 determines the arrangement of the group 131 around the center O according to the second predetermined rule and the arrangement of the UI components 13 of the group 131 in the group 131.

In block 703, the generating module 201 generates the group 131 by splicing the UI components 13 of the corresponding group 131 together, and generates the dynamic map-type graphic interface 32 by splicing the group 131 together around the center O. In detail, the generating module 201 generates the groups 131 by splicing the UI components 13 of the corresponding group 131 together according the determined arrangement of the UI components 13 in the group 131.

In block 704, the dynamic map-type graphic interface 32 is stored in the storage unit 40 of the electronic device 100.

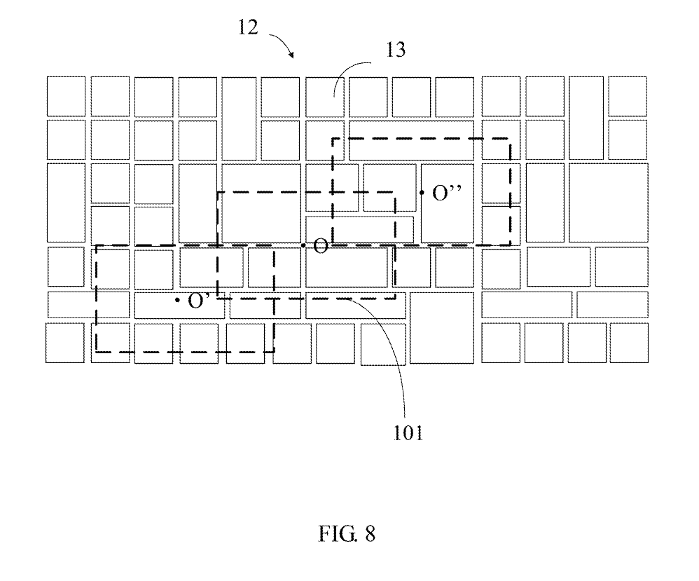

FIG. 8 illustrates when the size of the dynamic map-type graphic interface 12 is larger than a display size of the display unit 10, the UI controlling module 202 of the processing unit 20 determines a point of the dynamic map-type graphic interface 12 as a display center, then controls the display unit 10 to display a partial region 101 of the dynamic map-type graphic interface 12 centered around the display center. In this embodiment, a size of the partial region 101 is the size of the display unit 10.

In at least one embodiment, the center O is determined as the display center. In other embodiments, any point of the map-type graphic interface 12, such as a point O′ or a point O″, can be defined as the current display center. The current display center can be the most recent display center or be set by a user.

The input unit 30 is configured to receive a manual input and generate an input command in response to the input. The input controlling module 205 of the processing unit 20 generates corresponding control signals according to the different input commands. The UI controlling module 202 controls the display center of the dynamic map-type graphic interface 12 to move according to the control signal when the input command is the movement command.

For example, FIG. 8, illustrates the UI controlling module 202 controls the display center of the dynamic map-type graphic interface 12 to move from the center O to the point O′ or O″, then the partial region 101 is moved accordingly around the point O′ or the point O″.

When the display center is adjacent to a boundary of the dynamic map-type graphic interface 12, the UI controlling module 202 redefines the display center, such that the partial region 101 is within the dynamic map-type graphic interface 12.

The user can select and activate the UI component 13 displayed on the display unit 10 by the input unit 30 to start the corresponding application program.

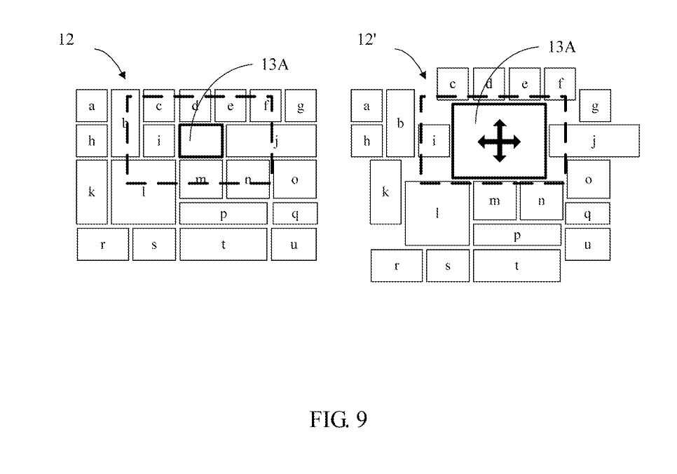

FIG. 9 illustrates an overview process of the dynamic map-type graphic user interface 12, when the user inputs a time-extended selection command via the input unit 30. The overview controlling module 206 determines a new size of the selected UI component 13. The generating module 201 updates the dynamic map-type graphic interface 12 by updating the size of the selected UI component according the new size of the selected UI component 13 and stores the updated dynamic map-type graphic interface 12 in the storage unit 40 of the electronic device 100.

User may input the time-extended selection command by inputting a time-extended selection of a UI component 13, such as inputting a time-extended press on the touch screen or button, or inputting a time-extended left click on a mouse. The term “time-extended”, means that the icon selection, the press, or the action of a single click of the mouse is continued for not less than 2 seconds (eg), rather than for the very brief time which is normally required for these actions.

The new size of the selected UI component 13 is larger than the original size, for example, a longitudinal size of the selected UI component 13 is larger than the original longitudinal size, a transverse size of the selected UI component 13 is larger than the original transverse size, or both longitudinal size and transverse size are larger than the original.

In at least one embodiment, the generating module 201 stretches the selected UI component 13 according to the determined new size in at least one direction, and accordingly moves the other UI components 13 in the at least one direction to make room for the stretched UI component 13.

FIG. 9 illustrates both of the longitudinal size and the transverse size of the selected UI component 13 are larger than the original sizes, the generating module 201 stretches the selected UI component 13 in four directions, and accordingly moves the other UI components 13 in the four directions to make room for the stretched UI component 13.

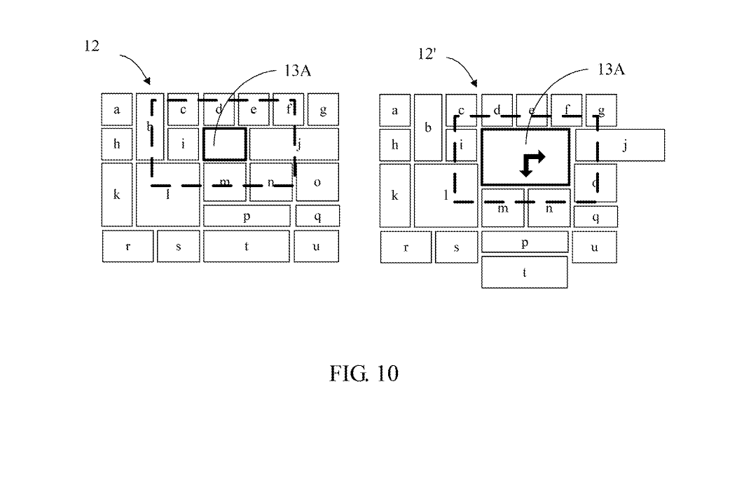

FIG. 10 illustrates both longitudinal size and transverse size of the selected UI component 13 are larger than the original sizes, the generating module 201 stretches the selected UI component 13 in a longitudinal direction and a transverse direction, and accordingly moves the other UI components 13 in the two directions to make room for the stretched UI component 13.

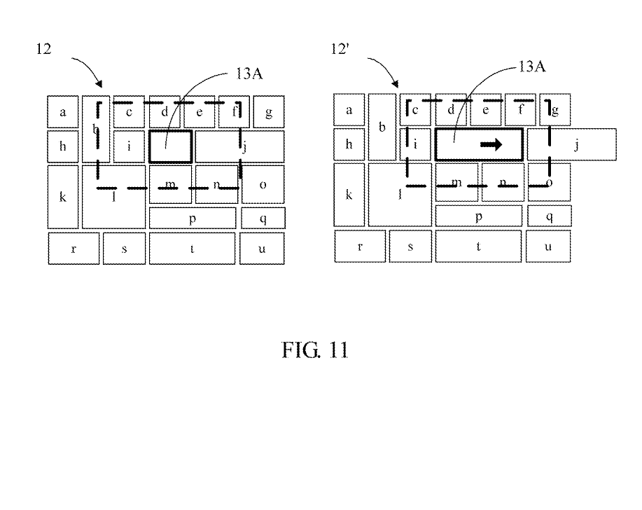

FIG. 11 illustrates that only a transverse size of the selected UI component 13 is larger than the original transverse size of the selected UI component 13, the generating module 201 stretches the selected UI component 13 in the a transverse direction, and accordingly moves the other UI components 13 in the corresponding direction to make room for the stretched UI component 13.

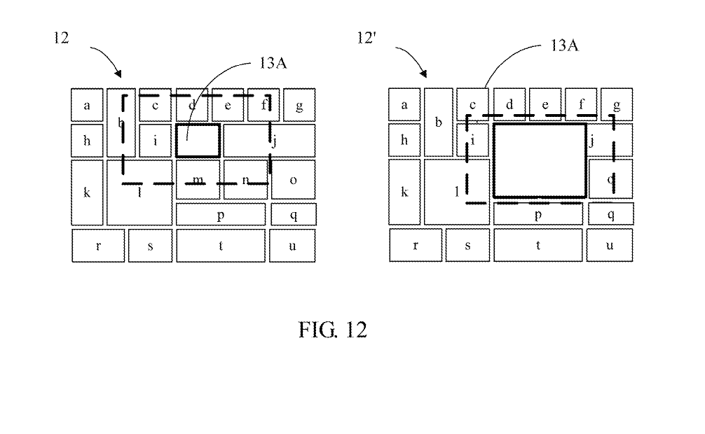

FIG. 12 illustrates that the size of the selected UI component 13 is stretched according to the determined new size in at least one direction, and the stretched UI component 13 covers the other UI components 13 in the stretched direction.

In at least one embodiment, the UI controlling module 202 controls the display center of the dynamic map-type graphic interface 12 to move to a center of the stretched UI component 13, then controls the display unit 10 to display a partial region of the dynamic map-type graphic interface 12 around the center of the stretched UI component 13.

The overview controlling module 206 further determines an overview to be displayed on the stretched UI component 13, and controls the display unit 10 to display the determined overview on the stretched UI component 13. In details, different UI components 13 couple to different overviews. For example, the stretched UI component 13 is a shortcut icon or a thumbnail icon of a multi-media file stored in the storage unit 40, the overview can be an introduction of the multi-media file or a preview picture of the multi-media file; if the stretched UI component 13 is shortcut icon of an application program, the overview can be an installation time of the application program, an introduction or the like.

It is easy to understand that the overview process also can be applied to the dynamic map-type graphic user interface 32 shown in the FIG. 6, the controlling method is the same as the overview process of the dynamic map-type graphic user interface 12 mentioned above.

The input unit 30 is configured to receive a manual input and generate an input command in response to the input. For example, if the input unit 30 is a touch panel, when the touch panel is swiped, the input unit 30 generates the movement command; if the touch panel is time-extended pressed, the input unit 30 generates the time-extended selection command. The input controlling module 205 of the processing unit 20 determines whether the input command is the movement command or the time-extended selection command.

When the touch panel is swiped, the input controlling module 205 determines a distance and a direction of the swipe, and generates the control signal according to the movement command. The control signal includes information of the distance and the direction of the swipe. The UI controlling module 202 determines a movement distance and a movement direction according to the control signal, and controls the display center of the dynamic map-type graphic interface 12 to move according to the determined movement direction and the determined movement distance.

In at least one embodiment, the movement direction is the same as the swiping direction, and the movement distance is proportional to the swiping distance. For example, when the swiping distance is 0.5 inches the determined movement distance is 1 unit. In another embodiment, the movement direction is opposite to the swiping direction.

In other embodiments, the input controlling module 205 determines a speed and a direction of the swipe, and generates the control signal according to the first movement command. The UI controlling module 202 determines a movement distance and a movement direction according to the speed and a direction of the swipe. For example, the movement distance can be determined according to a faster swipe gesture.

When the input controlling module 205 determines that the input command is the time-extended selection command, the overview controlling module 206 determines the new size of the selected UI component 13, the generating module 201 updates the dynamic map-type graphic interface 32 by updating the size of the selected UI component 13 to form a new dynamic map-type graphic interface 12′, which is stored in the storage unit 40 of the electronic device 100.

Furthermore, the UI controlling module 202 controls the display center of the dynamic map-type graphic interface 12 to move to a center of the stretched UI component 13, then controls the display unit 10 to display a partial region of the dynamic map-type graphic interface 12 around the center of the stretched UI component 13. The overview controlling module 206 further determines an overview displayed on the stretched UI component 13, and controls the display unit 10 to display the determined overview on the stretched UI component 13.

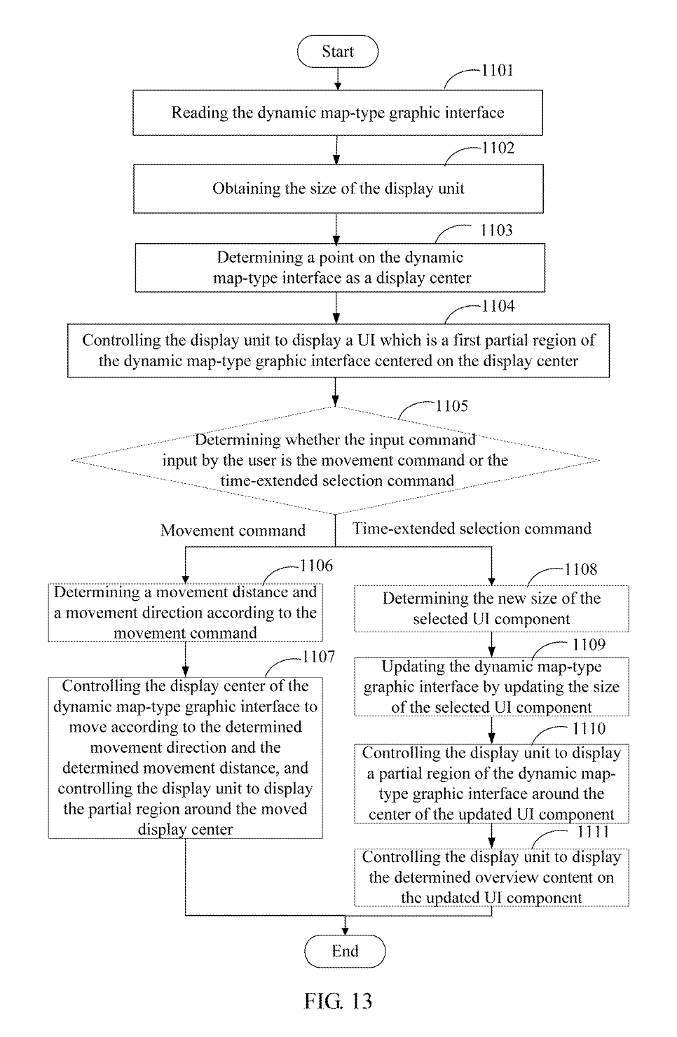

Referring to FIG. 13, a flowchart of a method for controlling the partial region 101 displayed on the electronic device 100, is presented in accordance with an example embodiment. The example method is provided by way of example, as there are a variety of ways to carry out the method. The method described below can be carried out using the configurations illustrated in FIG. 2, for example, and various elements of these figures are referenced in explaining example method. Each block shown in FIG. 13 represents one or more processes, methods or subroutines, carried out in the example method. Furthermore, the illustrated order of blocks is illustrative only and the order of the blocks can change according to the present disclosure. Additional blocks can be added or fewer blocks may be utilized, without departing from this disclosure. The example method can begin at block 111.

In block 111, the UI controlling module 202 reads the dynamic map-type graphic interface 12 from the storage unit 40.

In block 112, the UI controlling module 202 obtains the size of the display unit 10. In one embodiment, the UI controlling module 202 further determines whether the size of the display unit 10 is larger than the size of the dynamic map-type graphic interface 12. If the size of the display unit 10 is larger than the size of the dynamic map-type graphic interface 12, block 703 is implemented. Otherwise, the UI controlling module 202 controls the display unit 10 to display the content of dynamic map-type graphic interface 12.

In block 113, the UI controlling module 202 determines a point on the dynamic map-type interface as a display center. In this embodiment, the UI controlling module 202 determines the center O of the dynamic map-type graphic interface 12 as the display center. In other embodiments, any point selected by a user or the most recent display center can be defined as the current display center.

In block 114, the UI controlling module 202 controls the display unit 10 to display the partial region 101 of the dynamic map-type graphic interface 12 around the display center.

The method further includes the following blocks.

In block 115, input controlling module 205 of the processing unit 20 determines whether the input command input by the user is the movement command or the time-extended selection command. When the input command is the movement command, the flow goes to block 116; when the input command is the time-extended selection command, the flow goes to block 118

In block 116, the UI controlling module 202 determines a movement distance and a movement direction according to the movement command.

In block 117, the UI controlling module 202 controls the display center of the dynamic map-type graphic interface 12 to move according to the determined movement direction and the determined movement distance, and controls the display unit 10 to display the partial region 101 around the moved display center.

In block 118, the overview controlling module 206 determines the new size of the selected UI component 13 corresponding to the time-extended selection command. In this embodiment, the determined new size of the selected UI component 13 is large than the original size.

In block 119, the generating module 201 updates the dynamic map-type graphic interface 12 according the new size of the selected UI component 13 by updating the size of the selected UI component 13 to form a new dynamic map-type graphic interface 12′. In details, the generating module 201 updates the dynamic map-type graphic interface 12 by updating the size of the selected UI component 13 to form a new dynamic map-type graphic interface 12′. The generating module 201 further stores the new dynamic map-type graphic interface 12′ in the storage unit 40 of the electronic device 100.

In block 1110, the UI controlling module 202 controls the display center of the dynamic map-type graphic interface 12 to move to a center of the updated UI component 13, then controls the display unit 10 to display a partial region of the dynamic map-type graphic interface 12 around the center of the updated UI component 13.

In block 1111, the overview controlling module 206 further determines an overview displayed on the updated UI component 13, and controls the display unit 10 to display the determined overview on the updated UI component 13.

The UI component 13 can be enlarged via a time-extended selection command, and can display an overview relating to the associated application program or the file.

The dynamic map-type graphic interface 12 is a single-layer graphic interface made up of the UI components 13 spliced together. The UI components 13 are dynamically arranged around the center O. Furthermore, the dynamic map-type graphic interface 12 is compatible with different electronic devices having different display sizes.

The embodiments shown and described above are only examples. Many details are often found in the art such as the other features of an electronic device. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A method for dynamically controlling a map-type graphical user interface with a plurality of graphical representative user interface (UI) components comprising:
determining, at an electronic device, whether an input command input by a user is a time-extended selection command;
determining, at an electronic device, a new size of a selected UI component corresponding to the time-extended selection command; and
updating, based on the new size of the selected UI component at the electronic device, the map-type graphical user interface by updating the size of the selected UI component.

2. The method of claim 1, further comprising:
determining, at an electronic device, whether the input command input by the user is a movement command; and
controlling, at the electronic device, a display center of the dynamic map-type graphic interface to move to a center of the updated UI component, then controlling a display unit of the electronic device to display a partial region of the dynamic map-type graphic interface centered around the center of the updated UI component, wherein a size of the first partial region is the size of the display unit.

3. The method of claim 1, further comprising:
determining, at an electronic device, an overview to be displayed on the updated UI component, and controlling the display unit to display the determined overview on the updated UI component.

4. The method of claim 1, wherein the UI components comprises application icon and different kinds of widgets, each of the application icon and widgets is associated with a corresponding application program.

5. The method of claim 1, wherein the new size of the selected UI component is large than original size of the selected UI component.

6. The method of claim 5, further comprising:
updating, based on the new size of the selected UI component at the electronic device, the map-type graphical user interface by stretching the selected UI component according to the new size in at least one direction, and accordingly moves the other UI components in the at least one direction to make room for the stretched UI component.

7. The method of claim 5, further comprising:
updating, based on the new size of the selected UI component at the electronic device, the map-type graphical user interface by stretching the selected UI component according to the new size in at least one direction, wherein the stretched UI component covers the other UI components in the stretched direction.

8. An electronic device, comprising:
a display unit;
a processing unit; and
a storing unit configured to store a plurality of application programs and user interface (UI) components associated with the application programs, and a dynamic map-type graphic interface made up of the UI components spliced together around a center;
wherein the storing unit is further configured to store a plurality of instructions, which when executed by the processing unit, causes the processing unit to:
determining whether an input command input by a user is a time-extended selection command;
determining a new size of a selected UI component corresponding to the time-extended selection command; and
updating, based on the new size of the selected UI component, the map-type graphical user interface by updating the size of the selected UI component.

9. The electronic device of claim 8, wherein when the instructions executed by the processing unit, further causes the processing unit to:
determining whether the input command input by the user is a movement command; and
controlling a display center of the dynamic map-type graphic interface to move to a center of the updated UI component, then controlling a display unit of the electronic device to display a partial region of the dynamic map-type graphic interface centered around the center of the updated UI component, wherein a size of the first partial region is the size of the display unit.

10. The electronic device of claim 8, wherein when the instructions executed by the processing unit, further causes the processing unit to:
determining an overview to be displayed on the updated UI component, and controlling the display unit to display the determined overview on the updated UI component.

11. The electronic device of claim 8, wherein the UI components comprises application icon and different kinds of widgets, each of the application icon and widgets is associated with a corresponding application program.

12. The electronic device of claim 8, wherein the new size of the selected UI component is large than original size of the selected UI component.

13. The electronic device of claim 12, wherein when the instructions executed by the processing unit, further causes the processing unit to:
updating, based on the new size of the selected UI component, the map-type graphical user interface by stretching the selected UI component according to the new size in at least one direction, and accordingly moves the other UI components in the at least one direction to make room for the stretched UI component.

14. The electronic device of claim 12, wherein when the instructions executed by the processing unit, further causes the processing unit to:
updating, based on the new size of the selected UI component, the map-type graphical user interface by stretching the selected UI component according to the new size in at least one direction, wherein the stretched UI component covers the other UI components in the stretched direction.

15. A controlling system for controlling a dynamic map-type graphic interface of an electronic device, the dynamic map-type graphic interface comprising a plurality of user interface (UI) components spliced together around a center; the controlling system comprising:
an input controlling module configured to determine, at the electronic device, whether an input command input by a user is a time-extended selection command;
an overview controlling module configured to determine, at the electronic device, a new size of a selected UI component corresponding to the time-extended selection command; and
a generating module configured to update, based on the new size of the selected UI component at the electronic device, the map-type graphical user interface by updating the size of the selected UI component.

16. The controlling system of claim 15, wherein the input controlling module is further configured to determine whether an input command input by a user is a movement command; and the controlling system further comprises a UI controlling module configured to control, at the electronic device, a display center of the dynamic map-type graphic interface to move to a center of the updated UI component, then controlling a display unit of the electronic device to display a partial region of the dynamic map-type graphic interface centered around the center of the updated UI component, wherein a size of the first partial region is the size of the display unit.

17. The controlling system of claim 15, wherein the overview controlling module is further configured to determine an overview displayed on the updated UI component, and controlling the display unit to display the determined overview on the updated UI component.

18. The controlling system of claim 15, wherein the new size of the selected UI component is large than original size of the selected UI component.

19. The controlling system of claim 18, wherein the generating module updates the map-type graphical user interface by stretching the selected UI component according to the new size in at least one direction, and accordingly moves the other UI components in the at least one direction to make room for the stretched UI component.

20. The controlling system of claim 18, wherein the generating module updates the map-type graphical user interface by stretching the selected UI component according to the new size in at least one direction, and the stretched UI component covers the other UI components in the stretched direction.
